(19) United States
(12) Patent Application Publication
(10) Pub. No.: US 2017/0257867 A1
(43) Pub. Date: Sep. 7, 2017

(54) NON-CONTIGUOUS CHANNEL BONDING IN WIRELESS NETWORKS

(71) Applicants: Po-Kai HUANG, Santa Clara, CA (US); Qinghua LI, San Ramon, CA (US); Robert STACEY, Portland, OR (US)

(72) Inventors: Po-Kai HUANG, Santa Clara, CA (US); Qinghua LI, San Ramon, CA (US); Robert STACEY, Portland, OR (US)

(21) Appl. No.: 15/396,419

(22) Filed: Dec. 31, 2016

Related U.S. Application Data
(60) Provisional application No. 62/303,911, filed on Mar. 4, 2016.

(51) Int. Cl. H04W 72/04; H04W 74/08; H04W 74/00; H04L 5/00

(52) U.S. Cl. CPC H04W 72/0453; H04L 5/0041; H04W 74/0808; H04W 74/006

(57) ABSTRACT

Disclosed herein are systems and methods that are directed to non-contiguous channel bonding in wireless networks. Non-contiguous channels can refer to channels that are not adjacent to one another in the frequency domain. In one aspect, the non-contiguous channel bonding may support non-high efficiency (HE) physical layer convergence procedure protocol data unit (PPDU) communications. For example, non-high throughput (non-HT) devices, for example, legacy devices, can be supported using non-high throughput (non-HT) format frames. In one embodiment, this can include integration of non-contiguous channel bonding with multi-user (MU) request to send, clear to send (RTS/CTS) exchanges. In another embodiment, a trigger-initiated uplink (UL) PPDU can be supported with non-contiguous channel bonding.

### CROSS-REFERENCE TO RELATED APPLICATIONS

This application claims the benefit of U.S. Provisional Application No. 62/303,911 filed Mar. 4, 2016 the disclosure of which is incorporated herein by reference as if set forth in full.

### TECHNICAL FIELD

This disclosure generally relates to systems and methods for wireless communications and, more particularly, systems and methods to directed to non-contiguous channel bonding in wireless networks.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

In wireless networks, channel bonding (commonly used in IEEE 802.11 implementations) can refer to situations where two adjacent channels within a given frequency band are combined to increase throughput between two or more wireless devices.

### BRIEF DESCRIPTION OF THE DRAWINGS

FIG. 1 shows a diagram of an example network environment in accordance with the disclosure.

FIG. 2 shows an exemplary diagram of non-contiguous channel bonding for Orthogonal Frequency-Division Multiple Access (OFDMA) transmission in wireless networks, in accordance with example embodiments of the disclosure.

FIG. 3 shows an example diagram of non-contiguous channel bonding for multi-user (MU) Request to Send, Clear to Send (RTS/CTS) protection in wireless networks, in accordance with example embodiments of the disclosure.

FIG. 4 shows an example diagram of a trigger-initiated uplink (UL) High Efficiency (HE) Physical Layer Convergence Protocol (PLCP) Protocol Data Unit (Physical Layer Convergence Protocol (PLCP) Protocol Data Unit (PPDU)), in accordance with example embodiments of the disclosure.

FIG. 5 shows an example diagram of non-contiguous channel bonding for CTS-to-Self protection in wireless networks, in accordance with example embodiments of the disclosure.

FIGS. 6A-6B shows a diagram of an example operation of one or more devices implementing the disclosed systems, methods, and apparatus on a wireless network, in accordance with example embodiments of the disclosure.

FIG. 7 illustrates a functional diagram of an example communication station that may be suitable for use as a user device, in accordance with one or more example embodiments of the disclosure.

FIG. 8 shows a block diagram of an example machine upon which any of one or more techniques (for example, methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In various embodiments, a transmitting device, (for example, an Access Point, AP), may communicate with one or more receiving devices (for example, source (SRC) stations, STAs) on one or more channels. In one embodiment, the channel can be subdivided into a plurality of subchannels, including a primary subchannel and one or more secondary subchannels. In one embodiment, the transmitting device may determine, at a given time that a given subchannel in a channel for network communication between the transmitting device and one or more receiving devices is unusable. For example, the subchannel may be subject to interference, or one or more antennas associated with the subchannel may become inoperative. In one embodiment, the transmitting device may therefore elect to communicate on another subchannel (for example, a secondary subchannel in the channel) with the one or more receiving devices. If the transmitting device, receiving device, and/or the network is configured to operate on a contiguous channel bonding mode, one or more secondary channel(s) adjacent to the primary channel may be useable, while nonadjacent secondary channels to the primary channel may not be useable. Accordingly, if the adjacent subchannel(s) are unavailable the remaining secondary subchannel(s) may be dropped. This can lead to a decrease in network throughput and/or network efficiency, as less subchannels are available for data transmission between the transmitting device and the receiving device on the network. Moreover, such a decrease in throughput and/or network efficiency may occur in situations where the network is operating in a mixed-mode, that is, when both high-efficiency (HE) and/or high-throughput (HT) device and legacy devices communicating on the network. An example of a mixed-mode of operation for the network can include a network where both HE devices and/or HT devices operate, for example, using IEEE 802.11ax protocols, while one or more legacy devices operate on the same network using, for example, 802.11ac protocols (and less recent protocols).

In various embodiments, disclosed herein are systems, methods, and apparatus that are directed to non-contiguous channel bonding in wireless networks. In one embodiment, non-contiguous channels can refer to channels (and/or subchannels) that are not adjacent to one another, for example, in the frequency domain. In one embodiment, the systems, methods, and apparatus can be used in conjunction with Orthogonal Frequency-Division Multiple Access (OFDMA) transmission and reception methods and protocols on a wireless network. In another embodiment, the systems, methods, and apparatus can be used in accordance with IEEE 802.11ax standards and protocols.

In one embodiment, during communication between two devices (for example, a transmitting device such as an AP, and a STA) one or more frames may be sent and received between the devices. These frames may include one or more fields (or symbols) that may be based on one or more definitions specified in an IEEE 802.11 standard. In one embodiment, in a high-efficiency mode of communication (for example, in HEW) these one or more fields of the frame may be represented by one or more OFDMA symbols. In one embodiment, the one or more fields may further include both legacy signal fields and high efficiency signal fields. Furthermore, a high efficiency signal field (HE-SIG) may be made up of two high efficiency signal fields (for example, HE-SIG-A and HE-SIG-B). HE-SIG-A and/or HE-SIG-B may, alternatively or additionally, describe one or more attributes or parameters related to the network, transmission or reception protocol, and/or the one or more frames transmitted between devices. For example, the HE-SIG-A and/or HE-SIG-B fields can include information that relates, among other things, to the channel or subchannel width for transmission or reception, of frames on the network one or more modulation and/or coding schemes to be used in connection with the transmission or reception of frames on the network, and whether the frame(s) include a single-user frame or a multi-user frame.

In one embodiment, the high efficiency signal fields may be encoded across an entire bandwidth (for example, 80 MHz) of the communication channel or may be encoded within each approximately 20 MHz subchannels of the communication channel. In the case where the high efficiency signal fields may be encoded across within each approximately 20 MHz subchannels of the communication channel, the information in each subchannel can be independent and separately encoded in each subchannel. In a further embodiment, instead of independently encoding the data over the entire channel or each subchannel, the data may be encoded over one or more groups of subchannels. For example, if the channel is an 80 MHz channel, there may be two groups of subchannels, where each group includes two approximately 20 MHz subchannels.

In various embodiments, networks implementing non-contiguous channel bonding may support non-HE PPDU communications on the network between transmitting devices and receiving devices, using one or more non-HE and/or non-HT format frames. In particular, for non-HT format frames, the frame can be carried in non-HT or non-HT duplicate PPDU. In one embodiment, non-high throughput (non-HT) devices, for example, legacy devices, can be supported using non-high throughput (non-HT) format frames. In one embodiment, non-contiguous channel bonding may support non-HE PPDU communications using non-contiguous channel bonding with multi-user (MU)-Request to Send/Clear to Send (RTS/CTS) exchanges. In another embodiment, a trigger-initiated uplink (UL) PPDU can be supported with non-contiguous channel bonding. In yet another embodiment, non-contiguous channel bonding may support non-HE PPDU communications using non-contiguous channel bonding with CTS-to-self exchanges, for example, by the transmitting device.

In various embodiments, an example of the operation of the disclosed systems, methods, and apparatus herein follows. In one embodiment, a transmitting device can contend and/or performs backoff on a primary channel (for example, 20 MHz channel) of a wireless network. In one embodiment, the contention can refer to a method that can be used by wireless devices to share a broadcast medium. In contention, any device in the network can transmit data at any time (first come-first served). In one embodiment, to avoid collision, carrier sensing mechanisms can be used. In one embodiment, the device can listen to the network before attempting to transmit. If the network is busy, the device can wait until network is not busy. In carrier detection, the device continues to listen to the network as they transmit. If the device detects another signal from a second device that interferes with the signal it is sending, the device can stop transmitting. Both devices then wait for random amount of time and attempt to retransmit (which can be represented by the backoff process). In another embodiment, the backoff be performed after a predetermined duration.

In one embodiment, the transmitting device determines that it can transmit on primary channel and performs Clear Channel Assessment (CCA) on secondary channel(s) (for example, 20 MHz and/or 40 MHz and/or 80 MHz) channel(s)) to determine if transmitting device can perform duplicate non-HT transmission on the secondary channel(s). In one embodiment the transmitting device can determine that a first secondary channel (for example, the secondary 20 MHz channel) is busy and that a second secondary channel (for example, the secondary 40 MHz channel) is idle.

In one embodiment the transmitting device can determine that the transmission of duplicate non-HT format on primary channel and the idle secondary channel is supported. In one embodiment the transmitting device can transmit a frame (for example, a trigger frame or MU-RTS) in non-HT duplicate format on the primary channel and secondary 40 MHz channel to one or more receiving devices.

In one embodiment the transmitting device can determine one or more subchannels that a receiving device(s) responds on using the frame (for example, the trigger frame or the MU-RTS). In one embodiment the frame can indicate that the receiving device(s) is to respond to the transmitting device on one or more subchannels that are the frame is being exchanged on the network. In one embodiment the receiving device(s) can respond to the frame in order to respond to the transmitting device. In another embodiment the receiving device(s) can respond to the transmitting device on the one or more subchannels specified by the frame. In one embodiment the receiving device(s) can respond to the transmitting device with HE PPDU (for example, the HE UL MU PPDU). In another embodiment the receiving device(s) can respond to the transmitting device with non-HT or non-HT duplicate PPDU.

In another embodiment the receiving device(s) can perform carrier sensing on the one or more subchannels specified by the frame to respond to the transmitting device. In one embodiment the receiving device(s) can respond to the transmitting device on one or more subchannels determined to be idle as indicated by carrier sensing performed, for example, by the receiving device. In an embodiment the transmitting device can respond to the receiving device(s) with one or more HE MU PPDU frame(s) over one or more non-contiguous subchannels to respond to the acknowledgement from the one or more receiving device(s).

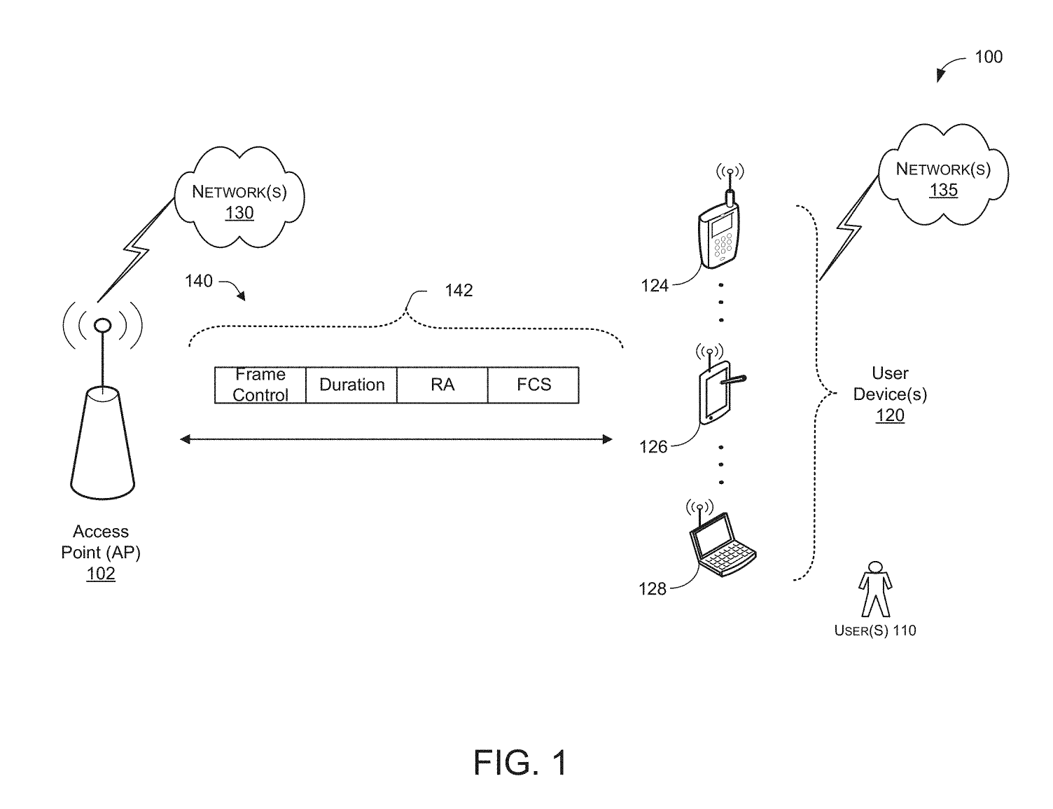

FIG. 1 is a network diagram illustrating an example network environment, according to some example embodiments of the present disclosure. In one embodiment, wireless network 100 may include one or more user devices 120 and one or more access point(s) (AP) 102, which may communicate in accordance with IEEE 802.11 communication standards, including IEEE 802.11ax. In another embodiment, the user device(s) 120 may be mobile devices that are non-stationary and do not have fixed locations.

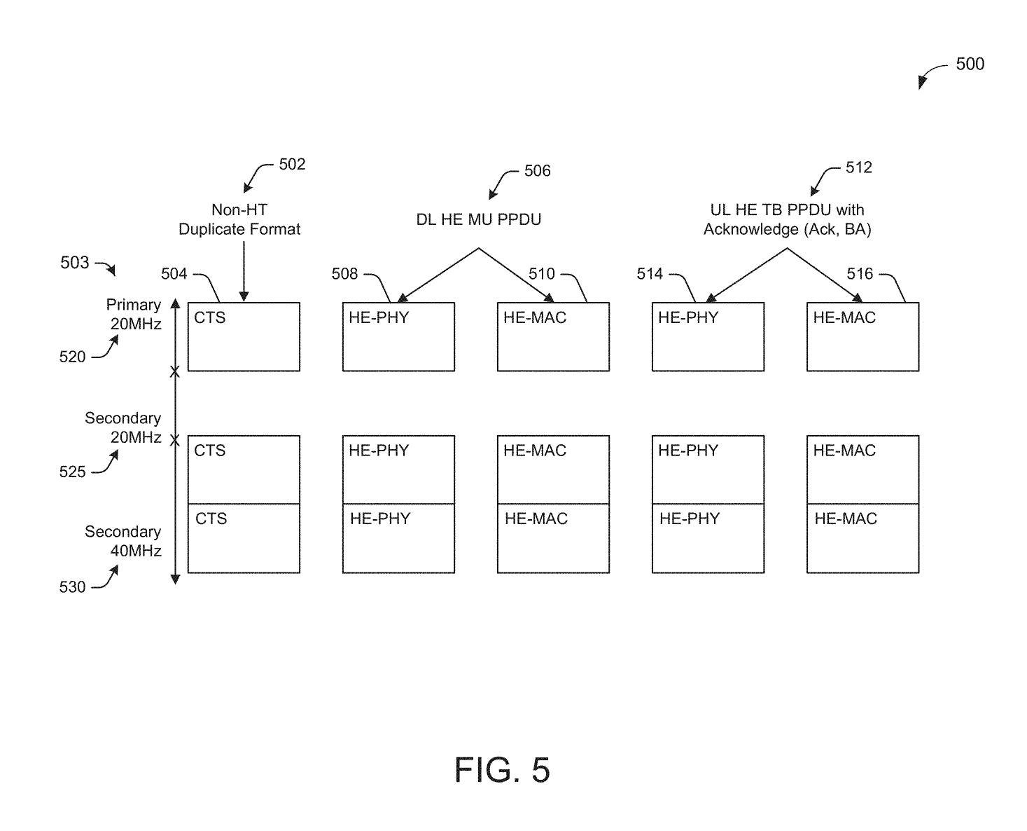

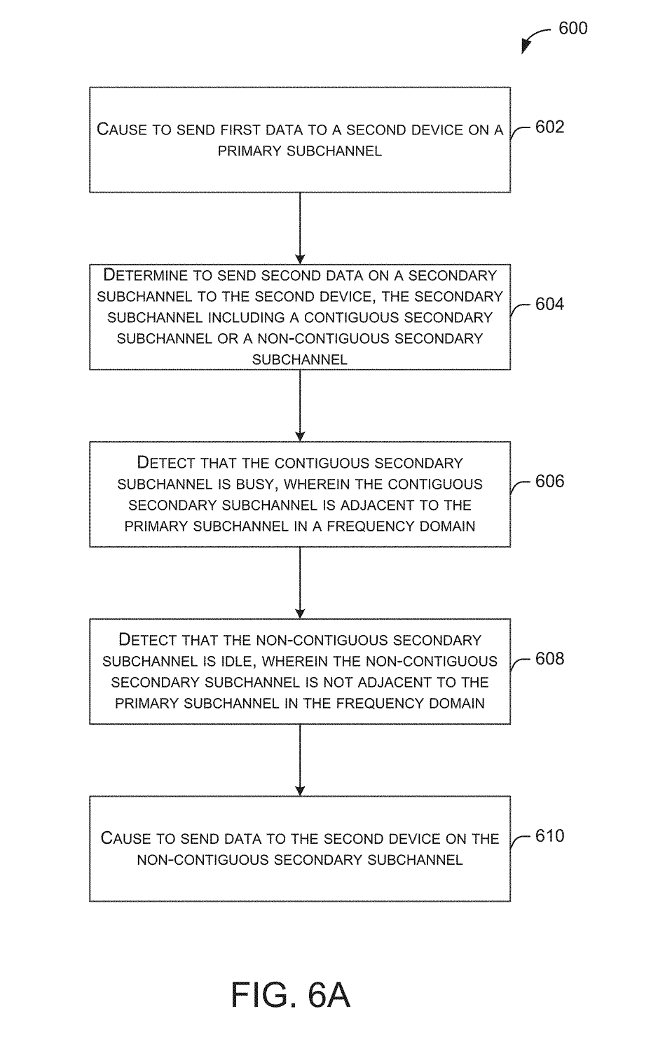

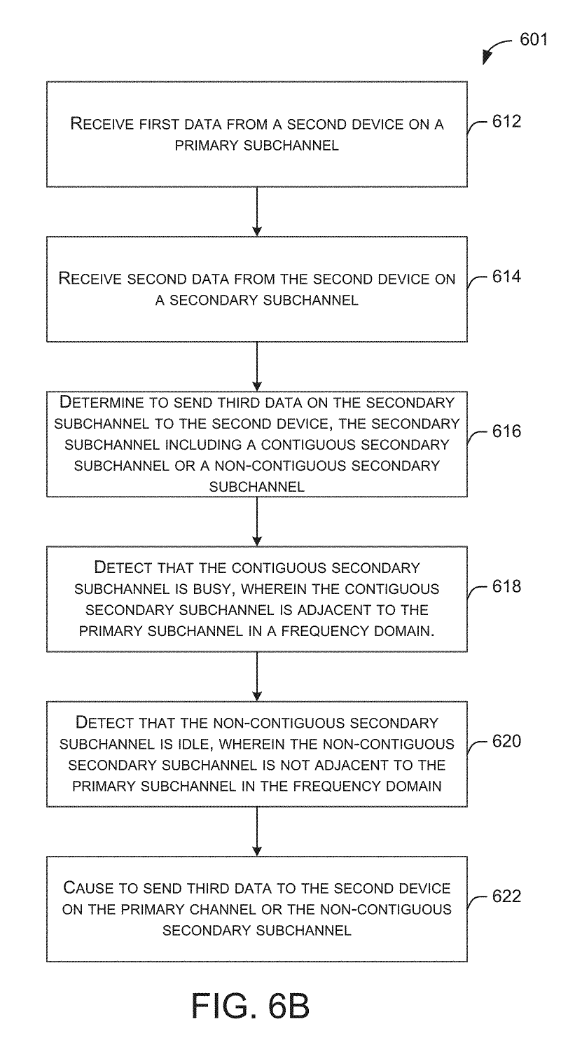

The user device(s) 120 (for example, 124, 126, or 128) may include any suitable processor-driven user device including, but not limited to, a desktop user device, a laptop user device, a server, a router, a switch, an access point, a smartphone, a tablet, wearable wireless device (for example, bracelet, watch, glasses, ring, etc.) and so forth. In some embodiments, the user devices 120 and AP 102 may include one or more computer systems similar to that of the functional diagram of FIG. 5 and/or the example machine/system of FIG. 6, to be discussed further.

Returning to FIG. 1, any of the user device(s) 120 (for example, user devices 124, 126, 128), and AP 102 may be configured to communicate with each other via one or more communications networks 130 and/or 135 wirelessly or wired. In one embodiment, any of the user device(s) 120 (for example, user devices 124, 126, 128), and AP 102 may be configured to communicate with each other using one or more protocols, including, but not limited to, IEEE 802.11ax and/or 802.11ac protocols (and less recent protocols). Any of the communications networks 130 and/or 135 may include, but not limited to, any one of a combination of different types of suitable communications networks such as, for example, broadcasting networks, cable networks, public networks (for example, the Internet), private networks, wireless networks, cellular networks, or any other suitable private and/or public networks. Further, any of the communications networks 130 and/or 135 may have any suitable communication range associated therewith and may include, for example, global networks (for example, the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (for example, user devices 124, 126, 128), and AP 102 may include one or more communications antennae. Communications antenna may be any suitable type of antenna corresponding to the communications protocols used by the user device(s) 120 (for example, user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (for example, user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (for example 802.11b, 802.11g, 802.11n), 5 GHz channels (for example 802.11n, 802.11ac), or 60 GHZ channels (for example 802.11ad). In some embodiments, non-Wi-Fi protocols may be used for communications between devices, such as Bluetooth, dedicated short-range communication (DSRC), Ultra-High Frequency (UHF) (for example IEEE 802.11af, IEEE 802.22), white band frequency (for example, white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (for example, AP 102) establishes communication with one or more user devices 120 (for example, user devices 124, 126, and/or 128), the AP may communicate in the downlink direction by sending data frames (for example 140, 142). The data frames may be preceded by one or more preambles that may be part of one or more headers. These preambles may be used to allow the user device to detect a new incoming data frame from the AP. A preamble may be a signal used in network communications to synchronize transmission timing between two or more devices (for example, between the APs and user devices).

Similarly, when an STA (for example, user devices 124, 126, and/or 128) establishes communication with an AP (for example, AP 102), the STA (for example, user devices 124, 126, and/or 128) may communicate in the uplink direction by sending data frames (for example 140, 142). The data frames may be preceded by one or more preambles that may be part of one or more headers. These preambles may be used to allow the AP to detect a new incoming data frame from the STA (for example, user devices 124, 126, and/or 128).

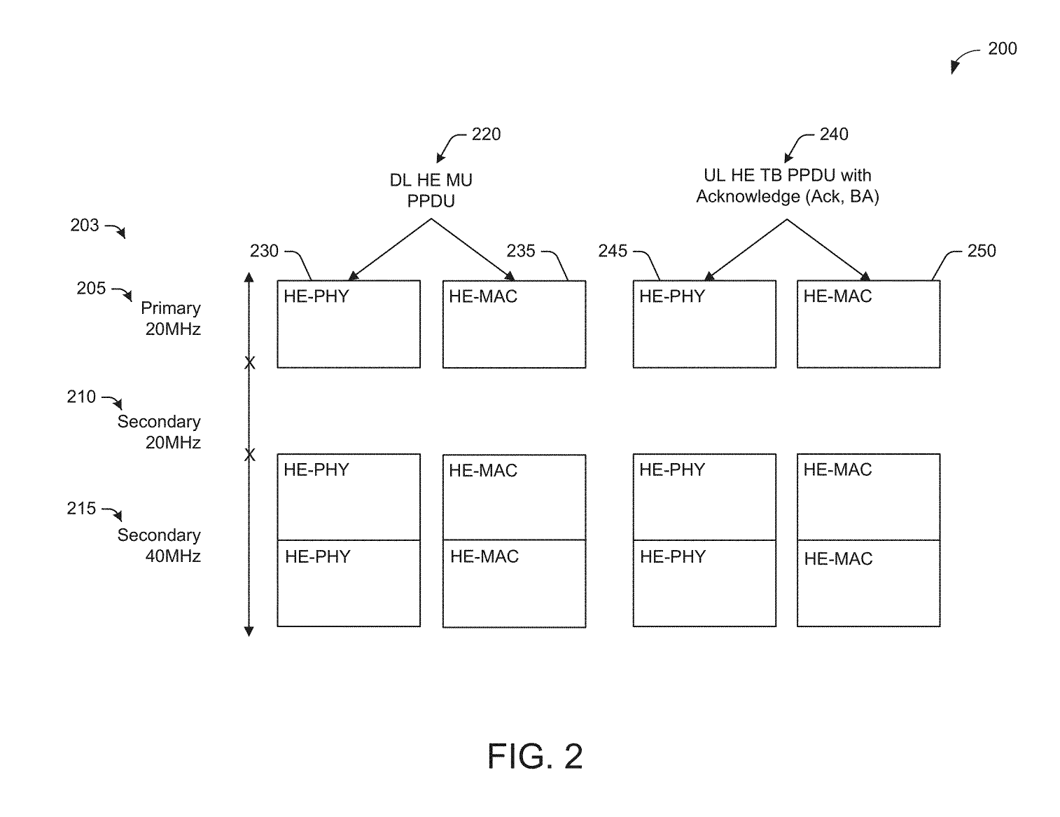

FIG. 2 shows an exemplary diagram 200 of frames for transmission (for example, using OFDMA) over a wireless network using non-contiguous channel bonding, in accordance with example embodiments of the disclosure. In one embodiment, the transmitting device (for example, AP 102 of FIG. 1) can transmit data to one or more receiving devices on a primary subchannel (for example, the approximately 40 MHz subchannel 205). In one embodiment, the transmitting device can transmit data to one or more receiving devices on secondary subchannels (for example, the secondary approximately 20 MHz subchannel 210 and/or one or more of the approximately 40 MHz subchannels that comprise an approximately 40 MHz subchannel 215). In another embodiment, the transmitting device can transmit data on a secondary subchannel (for example, the one or more of the approximately 40 MHz subchannels that comprise an approximately 40 MHz subchannel 215) even if another secondary subchannel (for example, the secondary 20 MHz subchannel 210) that is adjacent to the primary subchannel 205 is unavailable or detected to be busy (for example, through a Clear Channel Assessment (CCA) or other similar determination). Moreover, in one embodiment, the secondary subchannel (for example, the approximately 40 MHz subchannel 215) can be non-contiguous with respect to the primary subchannel (for example, the approximately 40 MHz primary subchannel 205).

As further shown in FIG. 2, the communications on the subchannels can comprise, for example, a downlink (DL) HE multi-user (MU) PPDU 220. Further, the DL HE MU PPDU can comprise both HE-physical (PHY) frames 230 and HE-Medium Access Control (MAC) frames 235. In one embodiment, the HE-physical (PHY) frames 230 can serve as a preamble to the downlink (DL) HE multi-user (MU) PPDU 220.

Additionally, the communication on the subchannels can comprise an UL HE transport block (TB) PPDU with acknowledge and/or block acknowledgement (BA) 240. Further, the UL HE TB PPDU with acknowledge and/or BA 240 can comprise both HE-physical (PHY) frames 245 and HE-Medium Access Control (MAC) frames 250. In one embodiment, the HE-physical (PHY) frames 245 can serve as a preamble to the uplink (UL) HE multi-user (MU) PPDU 240. In some aspects, the channel 203 can include one or more subchannels having, for example, an approximately 20 MHz subchannel granularity. It can be understood, however, that in other embodiments, the channel 203 can include one or more subchannels having greater or smaller granularity, for example, an approximately 40 MHz subchannel granularity, or approximately 10 MHz subchannel granularity. In one embodiment, one or more subchannels (for example, the approximately 40 MHz subchannel 205 and the secondary approximately 40 MHz subchannels 215) may non-contiguous with respect to one other in the frequency domain.

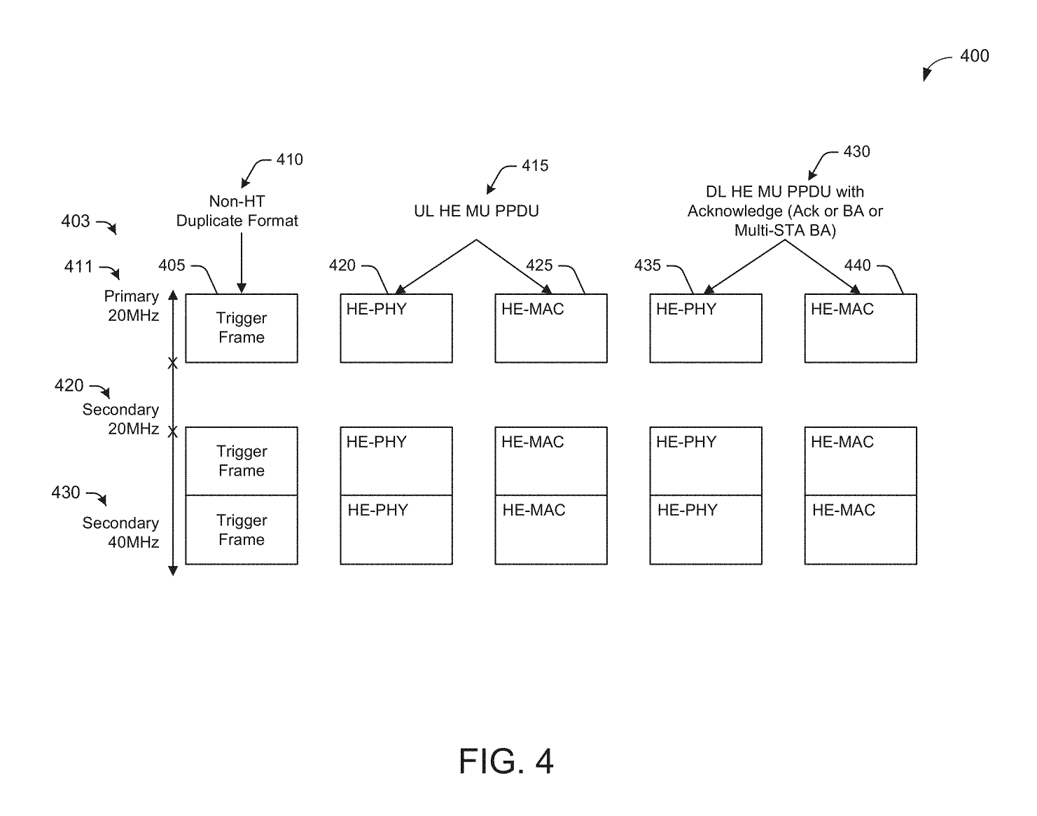

In various aspects, the disclosed systems, methods, and apparatus can permit non-contiguous channel bonding with non-HT format frame transmission on a wireless network. In particular, the non-HT format frame transmission is carried in non-HT/non-HT duplicate PPDU format. In some aspects, the non-HT format transmission for non-contiguous channel bonding can enable, at least, multi-user (MU) Request to Send/Clear to Send (RTS/CTS) protection. In one embodiment, MU RTS/CTS protection can refer to the reduction and/or prevention of contentions and/or collisions in the communication between one or more non-HT and/or one or more non-HE (devices. Additionally, the disclosed systems, methods, and apparatus can permit the non-HT format transmission for non-contiguous channel bonding including, for example, trigger initiated UL HE PPDUs and CTS-to-Self protection. In one embodiment, the trigger initiated UL HE PPDUs and CTS-to-Self protection can also serve to reduce and/or prevent one or more contentions and/or collisions in the communication between non-HT and/or HT STAs, to be discussed further below, for example, in connection with FIGS. 4 and 5.

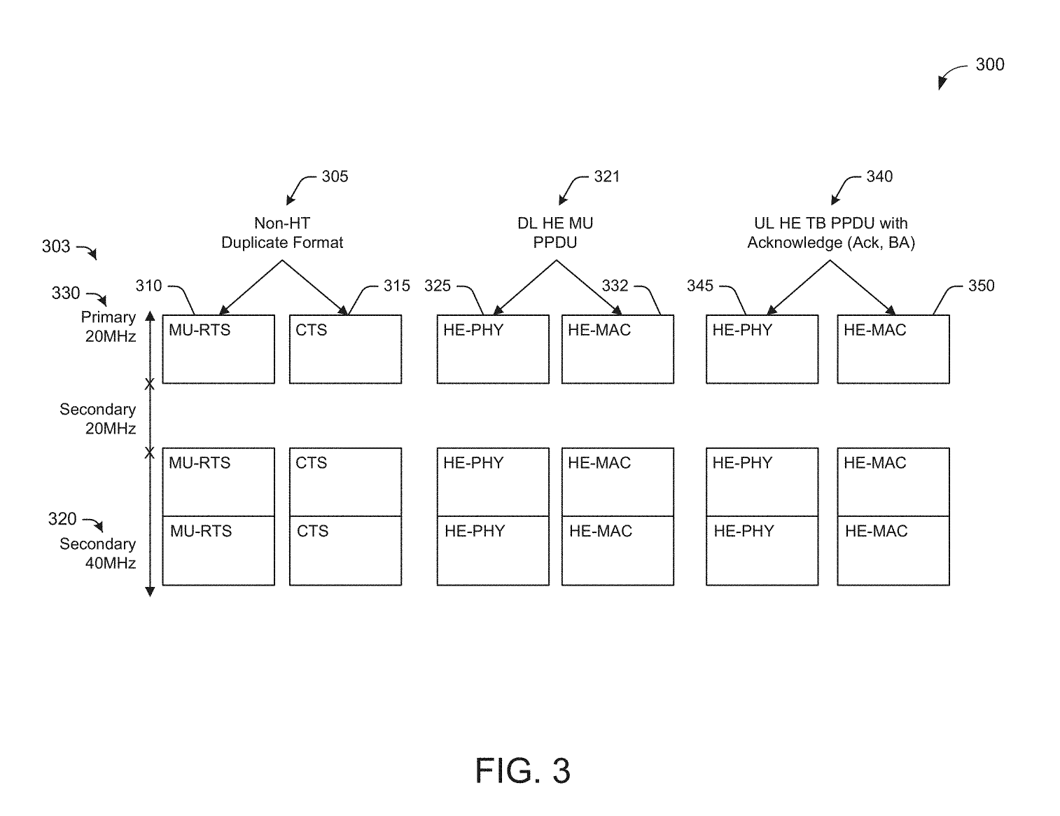

FIG. 3 shows an example diagram 300 of frames for transmission over a wireless network including non-contiguous channel bonding with non-HT format frames implementing MU-RTS/CTS protection, in accordance with example embodiments of the disclosure. In one embodiment, the transmitting device (for example, AP 102 of FIG. 1) can transmit non-HT format frames 305, also referred to as Non-HT duplicate format frames herein. In some aspects, the channel 303 can include one or more subchannels having, for example, an approximately 20 MHz subchannel granularity. It can be understood, however, that in other embodiments, the channel 303 can include one or more subchannels having greater or smaller granularity, for example, an approximately 40 MHz subchannel granularity, or approximately 10 MHz subchannel granularity. In one embodiment, one or more subchannels (for example, the approximately 40 MHz subchannel 205 and the secondary approximately 40 MHz subchannels 215) may non-contiguous with respect to one other in the frequency domain.

In one embodiment, the subchannels may non-contiguous with respect to one another. For example, a given approximately 20 MHz subchannel may be non-contiguous with respect to another approximately 20 MHz subchannel. In another aspect, the transmitting device may only transmit on the subchannels (for example, the approximately 40 MHz subchannel 320 comprising approximately 20 MHz subchannels) that are determined to be idle (for example, through a CCA or other similar determination). In one embodiment, the primary subchannel 330 (for example, an approximately 20 MHz primary subchannel) may, in some embodiments, be made available and/or be reserved for communication with one or more legacy devices.

As shown in FIG. 3, the communications comprising frames exchanged by the transmitting device and/or the receiving device on the subchannels on wireless network can comprise, for example, a non-HT duplicate format frame 305. In one embodiment, the non-duplicate format frame 305 can additionally comprise MU-RTS frames 310 and CTS frames 315. Moreover, in one embodiment, the communications on the subchannels can comprise, for example, a downlink (DL) HE multi-user (MU) PPDU 321. Further, the DL HE MU PPDU 321 can comprise both HE-physical (PHY) frames 325 and HE-Medium Access Control (MAC) frames 332. Additionally, the communication on the subchannels can comprise an UL HE transport block (TB) PPDU with acknowledge (Ack or block acknowledgement (BA)) 340. Further, the UL HE TB PPDU with Acknowledge 340 can comprise both HE-physical (PHY) frames 345 and HE-Medium Access Control (MAC) frames 350. In one embodiment, the HE-physical (PHY) frames 325 can serve as a preamble to the downlink (DL) HE multi-user (MU) PPDU 321.

In one embodiment, the transmitting device may only support non-contiguous channel bonding for HE PPDU frames without providing legacy support in order to maximize communication efficiency with HE devices (for example, devices that operate with 802.11ax).

In one embodiment, the MU-RTS can be sent by the transmitting device (that is, for example, the AP of FIG. 1), the CTS can be sent by a receiving device (for example, a receiving STA similar to the user devices 120 of FIG. 1) to the receiving device. In another embodiment, the CTS sent by the receiving device to the transmitting device may be sent on non-contiguous subchannels (as shown in 315). In one embodiment, the CTS sent by the receiving device can be sent on non-contiguous subchannels in order to reduce the implementation complexity of the receiving device. In one embodiment, NAV protection can be performed on the neighborhood of the transmitting device and/or the receiving device. That is, a NAV can be set on the transmitting device and/or the receiving device in order to prevent and/or reduce collisions with other devices within a predetermined radius (defining the neighborhood) of the transmitting device and/or the receiving device.

In another embodiment, the transmitting device and/or the receiving device may be configured to support a pre-determined number and type of subchannels. This configuration of the transmitting device or the receiving device to support a pre-determined number and type of subchannels may be desirable at least to reduce implementation complexity, for example, on the transmitting device or the receiving device. For example, in one embodiment, the transmitting device and/or the receiving device may be configured to support a primary approximately 20 MHz subchannel and a non-contiguous secondary approximately 40 MHz subchannel. In another embodiment, the transmitting device and/or the receiving device may be configured to support a primary approximately 20 MHz subchannel and a non-contiguous secondary 80 MHz subchannel. In another embodiment, the transmitting device and/or the receiving device may be configured to support a primary approximately 20 MHz subchannel and a non-contiguous approximately 40 MHz subchannel in a secondary 80 MHz subchannel. In another embodiment, the transmitting device and/or the receiving device may be configured to support a primary approximately 20 MHz subchannel and a non-contiguous approximately 20 MHz subchannel in a secondary approximately 40 MHz subchannel. In another embodiment, the transmitting device and/or the receiving device may be configured to support a non-contiguous approximately 20 MHz subchannel in a secondary 80 MHz subchannel. Alternatively or additionally, it can be understood that the transmitting device and/or the receiving device may be configured to support non-contiguous combination of primary and secondary subchannels not listed here.

Additionally, in one embodiment, the transmitting device and/or the receiving device may not support non-contiguous channel bonding for a non-duplicate mode of operation on the wireless network. For example, the transmitting device and/or the receiving device may not support non-contiguous channel bonding for the non-duplicate mode operation 305 shown in FIG. 3, again for the purpose of reducing the complexity of decoding the transmission and/or reception of the one or more frames. In other embodiments, the one or more of the non-HT duplicate format frames (for example, the MU-RTS frames, the trigger frame, and CTS-to-self frames, to be discussed) may be allowed for transmission in the non-HT non-contiguous mode of operation, for example, in order to minimize implementation complexity on the transmitting device and/or the receiving device.

In one embodiment, the MU-RTS frame (for example, the MU-RTS frame 310 of FIG. 3) can be followed by a CTS response from the receiving device and can indicate the subchannel(s) to use, in the following DL HE MU PPDUs 321 and/or the UL HE TB PPDUs 340. Moreover, the indication by the receiving device to the transmitting device of which subchannel(s) to use can be transmitted using either subchannels that are either non-contiguous or subchannels that are contiguous with respect to the primary channel 330. In other embodiments, the CTS response 315 from the receiving device can indicate to the transmitting device a subchannel to use for subsequent MU-RTS frames, where the subchannel to use is a subchannel that is not the primary subchannel.

In some embodiments, if MU-RTS is transmitted from the transmitting device to the receiving device using a duplicate non-HT format frame, the receiving device can also respond to the MU-RTS frame with duplicate non-HT format frame. In one embodiment, the CTS response can be transmitted on a subchannel having an approximately 20 MHz subchannel granularity. It can be understood, however, that in other embodiments, the CTS response can be transmitted on one or more subchannels having greater or smaller granularity, for example, an approximately 40 MHz subchannel granularity, or approximately 10 MHz subchannel granularity. In some embodiments, the receiving device may only respond on the subchannel band indicated or otherwise specified by the MU-RTS frame 310 from the transmitting device. In other embodiments, the receiving device may be configured to respond on the primary channel (for example, the approximately 20 MHz primary subchannel 330), even if the indication in the MU-RTS 310 does not explicitly indicate response communications by the receiving device to the transmitting device on the primary approximately 20 MHz subchannel. In some embodiments, CCA sensing may be performed by the receiving device on the transmitting device for example, in order to determine which subchannel to send the CTS response. In one embodiment, the CCA may only be performed by the receiving device on the subchannels (for example, the approximately 40 MHz subchannels (as shown for example, by 330 and/or one of the approximately 20 MHz subchannels of the approximately 40 MHz subchannel 320) that are associated with the CTS response. Additionally, if the CCA results in a busy status in the transmitting device (for example, through physical sensing or virtual sensing), then receiving device may elect not to send a CTS response to the transmitting device, or may delay its CTS response to the transmitting device.

FIG. 4 shows an example diagram 400 of frames for transmission over a wireless network including non-contiguous channel bonding with non-HT format frames using trigger-frames, in accordance with example embodiments of the disclosure. In one embodiment, trigger frames 405 can be used by the transmitting and receiving devices. For example, a transmitting device (for example, an AP as shown and described by the AP 102 in connection with FIG. 1) can send a trigger frame to sleeping receiving devices (for example, the receiving devices as shown and described by the user devices 120 in connection with FIG. 1) that are programmed to respond and wake to such trigger frames. In one embodiment, the trigger frames 405 can comprise a non-HT duplication format 410. In one embodiment, the trigger frame can be configured such that the transmitting device can implement resource allocation for receiving device(s) that are polled for transmission, for example, using an UL PPDU. Moreover, in one embodiment, the data transmission may occur within one or more subchannels (for example, one or more approximately 20 MHz subchannels) that are used by the trigger frame. In one embodiment, resource allocation for receiving device(s) that are polled for transmission in the UL PPDU can be performed using contiguous subchannels, for example, in order to support non-contiguous channel bonding in HE modes of operation of the wireless network and associated transmitting devices and/or receiving devices.

In one embodiment, a response from a receiving device polled by the trigger frame can be preceded by a CCA performed by the receiving device on one or more subchannels for communication with the transmitting device. In some embodiments, the CCA may only be performed on the subchannels (for example, approximately 20 MHz subchannels) that are predetermined as being used for resource allocation, for example, by the transmitting device. In one embodiment, if the CCA results in a determination that the transmitting device to be busy (for example, through physical sensing or virtual sensing) on one or more subchannels, then the receiving device may elect not to respond to the trigger frame. Alternatively or additionally, in another embodiment, if the CCA results in a determination that the transmitting device to be busy on one or more subchannels, then the receiving device may elect to delay transmission to the trigger frame on the associated subchannels.

As shown in FIG. 4, the communications on the subchannels can comprise, for example, an uplink (UL) HE multi-user (MU) PPDU 415. Further, the UL HE MU PPDU 415 can comprise both HE-physical (PHY) frames 420 and HE-Medium Access Control (MAC) frames 425. Additionally, the communication on the subchannels can comprise a DL HE MU PPDU with Acknowledge (Ack or block acknowledgement (BA) or multi-STA BA) 430. Further, the DL HE MU PPDU with Acknowledge 430 can comprise both HE-physical (PHY) frames 435 and HE-Medium Access Control (MAC) frames 440. In one embodiment, HE-physical (PHY) frames 420 can serve as a preamble to the HE-Medium Access Control (MAC) frames 425. In some aspects, the channel 403 can include one or more subchannels having, for example, an approximately 20 MHz subchannel granularity. It can be understood, however, that in other embodiments, the channel 403 can include one or more subchannels having greater or smaller granularity, for example, an approximately 40 MHz subchannel granularity, or 10 MHz subchannel granularity. In one embodiment, one or more subchannels (for example, the approximately 20 MHz subchannel 420 and the secondary approximately 40 MHz subchannels 430) may non-contiguous with respect to one other in the frequency domain.

In one embodiment, the trigger frame can be sent by the transmitting device (that is, for example, the AP). In one embodiment, NAV protection can be performed on the neighborhood of the transmitting device and/or the receiving device(s). That is, a NAV can be set on the transmitting device and/or the receiving device(s) in order to prevent and/or reduce collisions with other devices within a predetermined radius (defining the neighborhood) of the transmitting device and/or the receiving device(s).

In one embodiment, transmitting trigger frame(s) over one or more non-contiguous subchannels, for example, transmitting trigger frame(s) over one or more non-contiguous subchannels as shown and described in connection with FIG. 4 can be as follows. In one embodiment, the transmitting device (for example, an AP) can first perform a Clear Channel Assessment (CCA) and/or contend for a primary channel (for example, a primary approximately 20 MHz channel 411). In one embodiment, the transmitting device can optionally perform backoff during the contention process for the primary channel 411. In one embodiment, the transmitting device can determine that the transmitting device can transmit frames to one or more receiving devices on the primary channel 410. Accordingly, the transmitting device can perform CCA sensing and/or content for secondary channels (for example, an secondary approximately 20 MHz channel 420 and/or a secondary approximately 40 MHz channel 430) in order to determine if the transmitting device can perform duplicate non-HT transmission on the secondary channels (for example, the approximately 20 MHz channel 420 and/or the secondary approximately 40 MHz channel 430). In one embodiment, the transmitting device can sense that one of the secondary channels (for example, the secondary 20 MHz channel 420) is busy and that another one of the secondary channels (for example, the secondary 40 MHz channel 430) is idle. In one embodiment, the transmitting device can then determine that the transmission of duplicate non-HT format frames 410 on the primary channel (for example, the primary approximately 20 MHz 411) and/or idle secondary channel (for example, the secondary 40 MHz channel 420) is supported by the network and/or the receiving device(s). In one embodiment, the transmitting device can transmit a trigger frame 405 with non-HT duplicate format on the primary channel (for example, the primary 20 Mhz channel 411) and the secondary channel (for example, the approximately 40 MHz channel 430).

In one embodiment, the transmitting device can determine that the responding band, that is the subchannel for communication used by a soliciting receiving device from the trigger frame. In another embodiment, the trigger frame may only indicate that the receiving device to respond on one or more subchannels is covered by the trigger frame.

In one embodiment, the soliciting STA can respond to the trigger frame. For example, the STA may only respond on the band that is indicated by the trigger frame. In one embodiment, the STA can respond with HE trigger-based PPDU (or called HE UL MU PPDU mentioned in the example). In one embodiment, the STA can perform carrier sensing on the band indicated by the trigger frame to respond. In another embodiment, the STA can respond if carrier sensing indicates idle. In one embodiment, the transmitting device (for example, the AP) can respond with HE MU PPDU frame(s) with non-contiguous transmission to respond acknowledgement to the STA.

FIG. 5 shows an example diagram 500 of non-contiguous channel bonding for CTS-to-Self protection, in accordance with example embodiments of the disclosure. In one embodiment, the transmitting device (for example, AP 102 of FIG. 1) can transmit non-HT duplicate format frames 502. In some aspects, the channel 503 can include one or more subchannels having, for example, an approximately 20 MHz subchannel granularity. It can be understood, however, that in other embodiments, the channel 503 can include one or more subchannels having greater or smaller granularity, for example, an approximately 40 MHz subchannel granularity, or 10 MHz subchannel granularity. In one embodiment, one or more subchannels (for example, the approximately 20 MHz subchannel 525 and the secondary approximately 40 MHz subchannels 530) may non-contiguous with respect to one other in the frequency domain. In another aspect, the transmitting device may only transmit on subchannels (for example, the non-contiguous approximately 40 MHz subchannel 530 comprising two approximately 20 MHz subchannels) that are determined to be idle (for example, through a CCA or other similar determination). The primary subchannel 520 (for example, an approximately 20 MHz primary subchannel 520) may, in some embodiments, be available and/or be reserved for communication with one or more legacy devices.

As shown in FIG. 5, the communications on the various subchannels can comprise, for example, a non-HT duplicate format frame 502. In one embodiment, the non-duplicate format frame 502 can additionally comprise CTS frames 504. In one embodiment, the CTS frames 504 can include a CTS-to-Self frame. Moreover, the communications on the subchannels can comprise, for example, a downlink (DL) HE multi-user (MU) PPDU 506. Further, the DL HE MU PPDU 406 can comprise both HE-physical (PHY) frames 508 and HE-Medium Access Control (MAC) frames 510. In one embodiment, the HE-physical (PHY) frames 508 can serve as a preamble to the downlink (DL) HE multi-user (MU) PPDU 510.

Additionally, the communication on the subchannels can comprise an UL HE transport block (TB) PPDU with acknowledge (Ack or block acknowledgement (BA)) 412. Further, the UL HE TB PPDU with Acknowledge 412 can comprise both HE-physical (PHY) frames 414 and HE-Medium Access Control (MAC) frames 516. In one embodiment, the HE-physical (PHY) frames 514 can serve as a preamble to the uplink (UL) HE multi-user (MU) PPDU 516.

In one embodiment, the transmitting device may only support non-contiguous channel bonding for HE PPDU frames without providing legacy support in order to maximize communication efficiency with HE devices (for example, devices that operate with IEEE 802.11ax).

In one embodiment, the CTS-to-Self frames 504 can be sent by the transmitting device (that is, for example, an AP) to the transmitting device (again, for example, the AP) itself. In another embodiment, the CTS-to-Self frames 504 may be transmitted over one or more non-contiguous subchannels. In one embodiment, the CTS-to-Self frames 504 may be transmitted over contiguous subchannels (not shown) in order to reduce the implementation complexity on either the transmitting device and/or the receiving device. In one embodiment, NAV protection can be performed on the neighborhood of the transmitting device and/or the receiving device. That is, a NAV can be set on the transmitting device and/or the receiving device in order to prevent and/or reduce collisions with other devices within a predetermined radius (defining the neighborhood) of the transmitting device and/or the receiving device.

In another embodiment, the transmitting device and/or the receiving device can be configured to only support a pre-determined number and type of subchannels. This may be desirable to reduce implementation complexity, for example, on transmitting device and/or the receiving device side. For example, in one embodiment, the transmitting device and/or the receiving device may be configured to support a primary approximately 20 MHz subchannel and a non-contiguous secondary approximately 40 MHz subchannel. In another embodiment, the transmitting device and/or the receiving device may be configured to support a primary approximately 20 MHz subchannel and a non-contiguous secondary 80 MHz subchannel. In another embodiment, the transmitting device and/or the receiving device may be configured to support a primary approximately 20 MHz subchannel and a non-contiguous approximately 40 MHz subchannel in a secondary 80 MHz subchannel. In another embodiment, the transmitting device and/or the receiving device may be configured to support a primary approximately 20 MHz subchannel and a non-contiguous approximately 20 MHz subchannel in a secondary approximately 40 MHz subchannel. In another embodiment, the transmitting device and/or the receiving device may be configured to support a non-contiguous approximately 20 MHz subchannel in a secondary 80 MHz subchannel. Alternatively or additionally, it can be understood that the transmitting device and/or the receiving device may be configured to support non-contiguous combination of primary and secondary subchannels not listed here.

Additionally, the transmitting device may be configured to not support non-contiguous channel bonding for a non-duplicate mode of operation (for example, non-duplicate mode operation 510 shown in FIG. 5), again for the purpose of reducing the complexity of encoding the transmission on the transmitting device side and/or decoding the transmission on the receiving device side. In other embodiments, only CTS-to-Self frames 504 may be allowed for transmission by the transmitting device to the transmitting device in the non-HT non-contiguous mode of operation. In one embodiment, this can be done to minimize implementation complexity on the transmitting device.

In one embodiment, for the CTS-to-Self frames 504 can indicate the subchannel(s) to use in the subsequent DL HE MU PPDU 506 and/or UL HE TB PPDU 512 frames. Moreover, in one embodiment, the indication of which subchannel(s) to use in the subsequent DL HE MU PPDU 506 and/or UL HE TB PPDU 512 frames can be transmitted using either non-contiguous channel bonding or contiguous channel bonding.

FIG. 6A shows a diagram of an example operation of one or more devices implementing the disclosed systems, methods, and apparatus on a wireless network, in accordance with example embodiments of the disclosure. In block 602, a device can execute computer instructions to cause to send first data to a second device on a primary subchannel. In one embodiment, the primary subchannel can be part of a communications channel on a wireless network. In one embodiment, the transmission and reception of data can be performed using Orthogonal Frequency-Division Multiple Access (OFDMA) transmission and reception methods and protocols on a wireless network. In one embodiment, the device or the second device comprises a non-high efficiency (non-HE) device or a non-high throughput (non-HT) device. In one embodiment, the device can include an Access Point (AP), and the second device can include a source (SRC) station (STA). In one embodiment, the primary subchannel can be approximately 20 MHz in bandwidth. In one embodiment, the primary channel can be designated for communication with one or more legacy devices. In one embodiment, the legacy devices can operate using, for example, IEEE 802.11ac protocols (and less recent protocols).

In one embodiment, the instructions to cause to send first data to the second device on the primary subchannel further comprise instructions to cause to send one or more non-HT frames to the second device. In one embodiment, the non-HT frames further comprise a multi-user (MU) Request to Send frame (RTS) sent from the device to the second device. In another embodiment, the device may receive a Clear to Send (CTS) response to the MU-RTS frame from the second device. In another embodiment, the non-HT frames further comprise a trigger frame sent from the device to the second device. In one embodiment, the device may send a non-HT frames comprising a Clear to Send (CTS)-to-Self frame to itself.

In block 604, the device can determine to send second data on a secondary subchannel to the second device, the secondary subchannel including a contiguous secondary subchannel or a non-contiguous secondary subchannel. In one embodiment, the determination to send second data on a secondary subchannel to the second device can be due to one or more user inputs, network conditions, predetermined transmission schedules of the device, or any number of external factors. In one embodiment, the secondary subchannel can have a bandwidth of approximately 20 MHz and/or 40 MHz. In one embodiment, the 40 MHz subchannel can include two 20 MHz subchannels. In one embodiment, the secondary subchannels can include a first subchannel(s) that are adjacent in frequency to the primary subchannel and a second subchannel(s) that are not adjacent in frequency to the primary subchannel.

In block 606, the device can determine that the contiguous secondary subchannel is busy, wherein the contiguous secondary subchannel is adjacent to the primary subchannel in a frequency domain. In one embodiment, the device can determine that a contiguous secondary subchannel is busy by performing a Clear Channel Assessment (CCA) on the contiguous secondary subchannel the for communication with the second device. In one embodiment, if the CCA results in a busy status (for example, through physical sensing or virtual sensing), then the device may elect not to send frames to the second device, or may delay sending frames to the second device.

In block 608, the device can determine that a non-contiguous secondary subchannel is idle, wherein the non-contiguous secondary subchannel is not adjacent to the primary subchannel in the frequency domain. In one embodiment, determining, by the device, that a contiguous secondary subchannel is busy or t that a non-contiguous secondary subchannel is idle further comprises performing a CCA on the contiguous secondary subchannel the for communication with the second device.

In block 610, the device can cause to send data to the second device on the non-contiguous secondary subchannel. In one embodiment, the instructions to cause to send first data to the second device on the primary subchannel or the instructions to cause to send second data on the non-contiguous secondary subchannel further comprise instructions to cause to send one or more non-HT frames to the second device. In one embodiment, the non-HT frames can include one or more fields that may further include both legacy signal fields and high efficiency signal fields. Furthermore, a high efficiency signal field (HE-SIG) may be made up of two high efficiency signal fields (for example, HE-SIG-A and HE-SIG-B). HE-SIG-A and/or HE-SIG-B may, alternatively or additionally, describe one or more attributes or parameters related to the network, transmission or reception protocol, and/or the one or more frames transmitted between devices. For example, the HE-SIG-A and/or HE-SIG-B fields can include information that relates, among other things, to the channel or subchannel width for transmission or reception, of frames on the network one or more modulation and/or coding schemes to be used in connection with the transmission or reception of frames on the network, and whether the frame(s) include a single-user frame or a multi-user frame.

In one embodiment, the non-HT frames further comprise a multi-user (MU) Request to Send frame (RTS) sent from the device to the second device. In another embodiment, the device may receive a Clear to Send (CTS) response to the MU-RTS frame from the second device. In another embodiment, the non-HT frames further comprise a trigger frame sent from the device to the second device. In one embodiment, the device may send a non-HT frames comprising a Clear to Send (CTS)-to-Self frame to itself. In one embodiment, the sending, by the device, second data on the non-contiguous secondary subchannel further comprise instructions to cause to send one or more uplink high efficiency (HE) multi-user (MU) physical layer convergence procedure protocol data unit (PPDU) frames or one or more downlink high efficiency (HE) transport block (TB) physical layer convergence procedure protocol data unit (PPDU) frames to the second device.

FIG. 6B shows a diagram of an example operation of one or more devices implementing the disclosed systems, methods, and apparatus on a wireless network, in accordance with example embodiments of the disclosure.

In block 612, the device can receive first data from a second device on a primary subchannel. In one embodiment, the primary subchannel can be part of a communications channel on a wireless network. In one embodiment, the transmission and reception of data can be performed using OFDMA transmission and reception methods and protocols on a wireless network. In one embodiment, the device or the second device comprises a non-high efficiency (non-HE) device or a non-high throughput (non-HT) device. In one embodiment, the device can include an SRC STA, and the second device can include a STA. In one embodiment, the primary subchannel can be approximately 20 MHz in bandwidth. In one embodiment, the primary channel can be designated for communication with one or more legacy devices. In one embodiment, the legacy devices can operate using, for example, IEEE 802.11ac protocols (and less recent protocols).

In one embodiment, the receiving, by a device, a first data from a second device on a primary subchannel further comprise receiving one or more non-HT frames from the second device. In one embodiment, the non-HT frames can further comprise a multi-user (MU) Request to Send frame (RTS) sent from the second device to the device. In another embodiment, the second device may receive a Clear to Send (CTS) response to the MU-RTS frame from the device. In another embodiment, the non-HT frames further comprise a trigger frame sent from the second device to the device.

In block 614, the device can receive second data from the second device on a secondary subchannel. In one embodiment, the secondary subchannel including a contiguous secondary subchannel or a non-contiguous secondary subchannel. In one embodiment, the receiving of the second data on a secondary subchannel can be due to one or more user inputs, network conditions, predetermined transmission schedules of the device and/or the second device, or any number of external factors. In one embodiment, the secondary subchannel can have a bandwidth of approximately 20 MHz and/or 40 MHz. In one embodiment, the 40 MHz subchannel can include two 20 MHz subchannels. In one embodiment, the secondary subchannels can include a first subchannel(s) that are adjacent in frequency to the primary subchannel and a second subchannel(s) that are not adjacent in frequency to the primary subchannel.

In block 616, the device can determine to send third data on the secondary subchannel to the second device, the secondary subchannel including a contiguous secondary subchannel or a non-contiguous secondary subchannel.

In one embodiment, the transmission of the third data on a secondary subchannel can be due to one or more user inputs, network conditions, predetermined transmission schedules of the device and/or the second device, or any number of external factors. In one embodiment, the secondary subchannel can have a bandwidth of approximately 20 MHz and/or 40 MHz. In one embodiment, the 40 MHz subchannel can include two 20 MHz subchannels. In one embodiment, the secondary subchannels can include a first subchannel(s) that are adjacent in frequency to the primary subchannel and a second subchannel(s) that are not adjacent in frequency to the primary subchannel.

In block 618, the device can determine that the contiguous secondary subchannel is busy, wherein the contiguous secondary subchannel is adjacent to the primary subchannel in a frequency domain. In one embodiment, the device can determine that a contiguous secondary subchannel is busy by performing a Clear Channel Assessment (CCA) on the contiguous secondary subchannel for communication with the second device. In one embodiment, if the CCA results in a busy status (for example, through physical sensing or virtual sensing), then the device may elect not to send frames to the second device, or may delay sending frames to the second device.

In block 620, the device can determine that the non-contiguous secondary subchannel is idle, wherein the non-contiguous secondary subchannel is not adjacent to the primary subchannel in the frequency domain.

In one embodiment, determining, by the device, that a contiguous secondary subchannel is busy or that a non-contiguous secondary subchannel is idle further comprises performing a CCA on the contiguous secondary subchannel the for communication with the second device.

In block 622, the device can send third data to the second device on the primary channel or the non-contiguous secondary subchannel. In one embodiment, sending third data to the second device on the primary subchannel or sending third data on the non-contiguous secondary subchannel further comprise instructions to cause to send one or more non-HT frames to the second device. In one embodiment, the non-HT frames can include one or more fields that may further include both legacy signal fields and high efficiency signal fields. Furthermore, a high efficiency signal field (HE-SIG) may be made up of two high efficiency signal fields (for example, HE-SIG-A and HE-SIG-B). HE-SIG-A and/or HE-SIG-B may, alternatively or additionally, describe one or more attributes or parameters related to the network, transmission or reception protocol, and/or the one or more frames transmitted between devices. For example, the HE-SIG-A and/or HE-SIG-B fields can include information that relates, among other things, to the channel or subchannel width for transmission or reception, of frames on the network one or more modulation and/or coding schemes to be used in connection with the transmission or reception of frames on the network, and whether the frame(s) include a single-user frame or a multi-user frame.

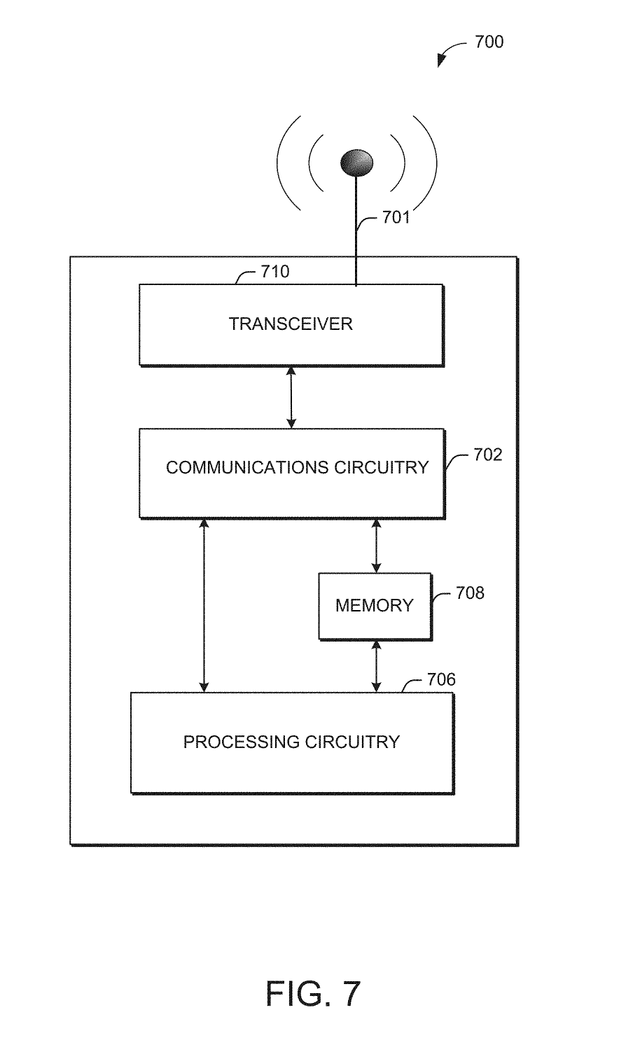

FIG. 7 shows a functional diagram of an exemplary communication station 700 in accordance with some embodiments. In one embodiment, FIG. 7 illustrates a functional block diagram of a communication station that may be suitable for use as an AP 102 (FIG. 1) or communication station user device 120 (FIG. 1) in accordance with some embodiments. The communication station 700 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 1-6.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device may, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

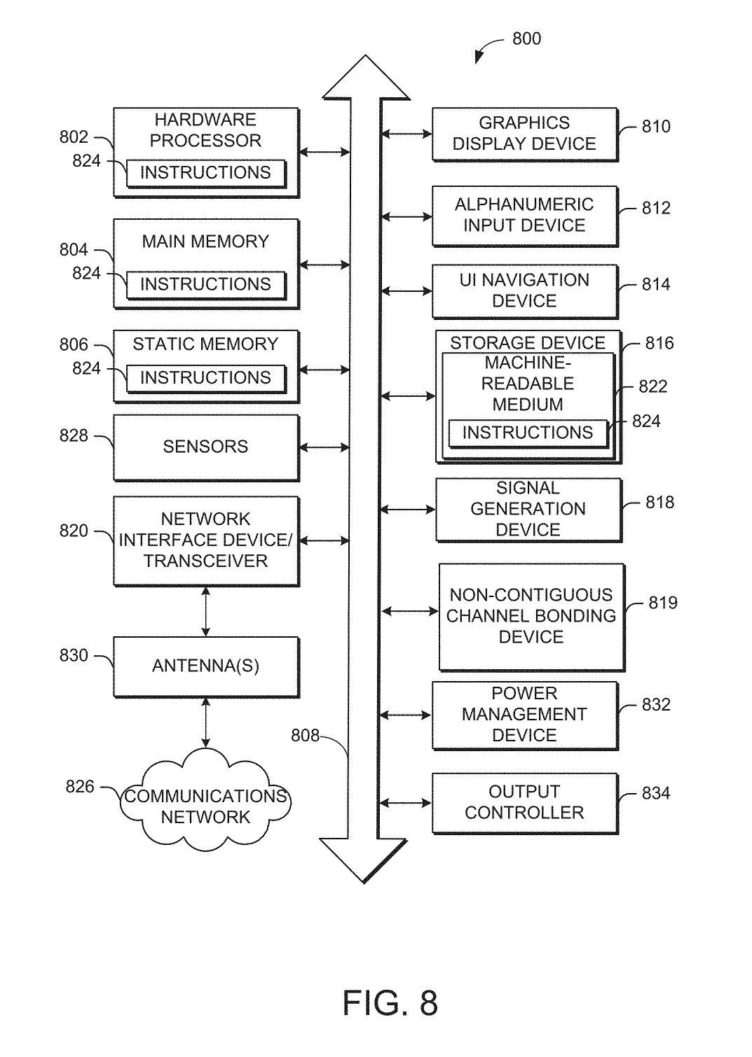

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 1004 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a non-contiguous channel bonding device 819, a network interface device/transceiver 820 coupled to antenna(s) 830, and one or more sensors 828, such as a global positioning system (GPS) sensor, compass, accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The non-contiguous channel bonding device 819 may be configured to cause to send first data to a second device on a primary subchannel; determine to send second data on a secondary subchannel to the second device, the secondary subchannel including a contiguous secondary subchannel or a non-contiguous secondary subchannel; determine that the contiguous secondary subchannel is busy, wherein the contiguous secondary subchannel is adjacent to the primary subchannel in a frequency domain; determine that the non-contiguous secondary subchannel is idle, wherein the non-contiguous secondary subchannel is not adjacent to the primary subchannel in the frequency domain; and cause to send data to the second device on the non-contiguous secondary subchannel. It is understood that the above are only a subset of what the non-contiguous channel bonding device 819 may be configured to perform and that other functions included throughout this disclosure may also be performed by the non-contiguous channel bonding device 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, for example, a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
cause to send first data to a second device on a primary subchannel;
determine to send second data on a secondary subchannel to the second device, the secondary subchannel including a contiguous secondary subchannel or a non-contiguous secondary subchannel;
determine that the contiguous secondary subchannel is busy, wherein the contiguous secondary subchannel is adjacent to the primary subchannel in a frequency domain;
determine that the non-contiguous secondary subchannel is idle, wherein the non-contiguous secondary subchannel is not adjacent to the primary subchannel in the frequency domain; and
cause to send data to the second device on the non-contiguous secondary subchannel.

2. The device of claim 1, wherein the device or the second device comprises a non-high efficiency (non-HE) device or a non-high throughput (non-HT) device.

3. The device of claim 1, wherein the instructions to determine that a contiguous secondary subchannel is busy or the instruction to determine that a non-contiguous secondary subchannel is idle further comprise instructions to perform a Clear Channel Assessment (CCA) on the contiguous secondary subchannel or the non-contiguous secondary subchannel.

4. The device of claim 1, wherein the instructions to cause to send first data to the second device on the primary subchannel or the instructions to cause to send second data on the non-contiguous secondary subchannel further comprise instructions to cause to send one or more non-HT physical layer convergence procedure protocol data unit (PPDU) format frames to the second device.

5. The device of claim 4, wherein the non-HT frames further comprise a multi-user (MU) request-to-send frame.

6. The device of claim 4, wherein the non-HT frames further comprise a trigger frame.

7. The device of claim 4, wherein the non-HT frames further comprise a clear-to-send (CTS)-to-self frame.

8. The device of claim 1, wherein the instructions to cause to send second data on the non-contiguous secondary subchannel further comprise instructions to cause to send one or more or one or more downlink high efficiency (HE) multi-user (MU) physical layer convergence procedure protocol data unit (PPDU) frames.

9. The device of claim 1, wherein the device or the second device comprises a high efficiency (HE) device.

10. The device of claim 1, further comprising a transceiver configured to transmit and receive wireless signals and an antenna coupled to the transceiver.

11. A device, comprising:
at least one memory that stores computer-executable instructions; and
at least one processor configured to access the at least one memory, wherein the at least one processor is configured to execute the computer-executable instructions to:
receive first data from a second device on a primary subchannel;
determine to send second data on the secondary subchannel to the second device, the secondary subchannel including a contiguous secondary subchannel or a non-contiguous secondary subchannel;
determine that the contiguous secondary subchannel is busy, wherein the contiguous secondary subchannel is adjacent to the primary subchannel in a frequency domain;
determine that the non-contiguous secondary subchannel is idle, wherein the non-contiguous secondary subchannel is not adjacent to the primary subchannel in the frequency domain; and
cause to send second data to the second device on the primary channel or the non-contiguous secondary subchannel.

12. The device of claim 11, wherein the causing to send second data, by the device, to the second device on the primary channel or the non-contiguous secondary subchannel to the second device is based at least in part on one or more subchannels specified the first data.

13. The device of claim 11, wherein the second data comprises an uplink (UL) high efficiency (HE) multi-user (MU) physical layer convergence procedure protocol data unit (PPDU) frame.

14. The device of claim 11, wherein the second data comprises a non-high efficiency (non-HT) or non-high throughput (non-HT) physical layer convergence procedure protocol data unit (PPDU) frame.

15. The device of claim 11, wherein the instructions to determine that a contiguous secondary subchannel is busy or the instructions to determine that a non-contiguous secondary subchannel is idle further comprise instructions to perform a clear channel assessment (CCA) on the contiguous secondary subchannel or the non-contiguous secondary subchannel.

16. A method, comprising:
sending first data to a second device on a primary subchannel;
determining to send second data on a secondary subchannel to the second device, the secondary subchannel including a contiguous secondary subchannel or a non-contiguous secondary subchannel;
determining that the contiguous secondary subchannel is busy, wherein the contiguous secondary subchannel is adjacent to the primary subchannel in a frequency domain;
determining that the non-contiguous secondary subchannel is idle, wherein the non-contiguous secondary subchannel is not adjacent to the primary subchannel in the frequency domain; and
causing to send data to the second device on the non-contiguous secondary subchannel.

17. The method of claim 15, wherein the device or the second device comprises a non-high efficiency (non-HE) device or a non-high throughput (non-HT) device.

18. The method of claim 15, wherein determining that a contiguous secondary subchannel is busy or determining that a non-contiguous secondary subchannel is idle further comprises performing a clear channel assessment (CCA) on the on the contiguous secondary subchannel or the non-contiguous secondary subchannel.

19. The method of claim 15, wherein causing to send first data to the second device on the primary subchannel or causing to send second data on the non-contiguous secondary subchannel further comprise sending one or more non-HT frames to the second device.

20. The method of claim 18, wherein the non-HT frames further comprise a multi-user (MU) request-to-send frame.

21. The method of claim 18, wherein the non-HT frames further comprise a trigger frame.

22. The method of claim 18, wherein the non-HT frames further comprise a clear-to-send (CTS)-to-self frame.
